(19) United States
(12) Patent Application Publication
(10) Pub. No.: US 2026/0192672 A1
(43) Pub. Date: Jul. 9, 2026

(54) DISPLAY DEVICE FOR A MOTOR VEHICLE

(71) Applicant: Brose Fahrzeugteile SE & Co. Kommanditgesellschaft, Coburg, Coburg (DE)

(72) Inventors: Felix EICHHORN, Scheblitz (DE); Markus FISCHER, Itzgrund (DE); Peter HORN, Kemmern (DE); Harald HUGEL, Bamberg (DE); Kirstin KNAUER, Hallstadt (DE); Philipp KONARSKI, Hallstadt (DE); Philipp LINK, Hallstadt (DE); Maik RIENECKER, Memmelsdorf (DE); Heino SCHALYO, Altendorf (DE); Rene SCHEEDE, Bamberg (DE); Simon SCHMUCK, Lautertal (DE)

(21) Appl. No.: 19/440,085

(22) Filed: Jan. 5, 2026

(30) Foreign Application Priority Data
Jan. 9, 2025 (DE) 102025100548.6

(51) Int. Cl. B60K 37/10; B60K 35/22; B60K 35/53

(52) U.S. Cl. CPC B60K 37/10; B60K 35/223; B60K 35/53

(57) ABSTRACT

A display device for a motor vehicle, having a foldable display that has a first display half and a second display half which are attached to each other by means of a hinge. The hinge is mounted so as to be movable by means of a guide in an adjustment direction, and the display device comprises an electric-motor-operated adjustment drive that drives the display.

### CROSS-REFERENCE TO RELATED APPLICATION

This application claims priority pursuant to 35 U.S.C. 119(a) to German Patent Office Application No. 102025100548.6, filed Jan. 9, 2025, which application is incorporated herein by reference in its entirety.

### FIELD

The invention relates to a display device for a motor vehicle that comprises a display.

### BACKGROUND

Motor vehicles, such as passenger cars, typically have a plurality of display devices by means of which motor vehicle status information is presented to the driver of the motor vehicle. To reduce the number of display devices while still being able to display a large amount of different information, such a display device usually comprises one display. The display is designed, for example, as an LCD or LED display. This also makes possible a flexible adjustment of the displayed information. Such a display device can also be used to provide information regarding a route within the context of a navigation system.

If the display device comprises the display, said display will also be usable by a motor vehicle passenger during a journey for surfing the internet or playing movies thereby. However, care must be taken to ensure that the display device is not in the driver's field of vision, otherwise this would impair his ability to drive the vehicle, potentially being distracted while driving. As a result, the display is usually relatively compact and/or structurally designed such that the driver has no view of it.

These requirements do not apply if the motor vehicle is stationary for a comparatively long period of time, for example in traffic or during charging if the motor vehicle is designed as an electric vehicle. In this case, the reduced display size reduces passenger comfort. Nor is it, for example, possible to see the display adequately from a driver's seat. As a solution the display is mounted on the headliner by means of a hinge, for example, so that it can be folded upward and stowed against the headliner while the vehicle is in motion. When the display is to be used, it can be folded down. The larger the display, the more space must be kept clear for adjusting the display. This can lead to a loss of comfort or require exiting from the vehicle to fold it down.

In one alternative, the display is retractably stored in a shaft. When the display is to be used, it is guided out of the shaft in parallel with its extension. The larger the display, the deeper the shaft needs to be. In the case of a dashboard, the depth of the shaft is limited due to the footwell located below it and the airbags installed therein. This makes a construction more difficult and limits the possible display size.

### SUMMARY

The object addressed by the invention is that of providing a particularly suitable display device for a motor vehicle, which expediently increases comfort and preferably reduces manufacturing costs and/or the space required.

Regarding the display device, this object is achieved according to the invention by the features of claim 1. Advantageous developments and embodiments form the subject-matter of the dependent claims.

The display device is suitable, in particular provided and configured, for mounting on a motor vehicle or at least forming a component of the motor vehicle when mounted. The motor vehicle is suitably land-based and preferably multi-lane. In this case, it is suitably possible to position the motor vehicle substantially freely, in particular on a road surface. For this purpose, the motor vehicle is expediently equipped with appropriate wheels. In summary, it is preferably possible to position the motor vehicle substantially independently of other conditions on land. In other words, the motor vehicle is suitably not rail-guided. Preferably, the motor vehicle is a passenger car or a commercial vehicle, such as a truck or bus. Alternatively, the motor vehicle is, for example, a ship/boat or an aircraft, such as an airplane.

The display device comprises a foldable display that has a first display half and a second display half. Expediently, the two display halves are essentially rectangular or cuboid. Preferably, the two display halves are identical in construction. For example, the two display halves are flexible and/or elastically deformable or are particularly preferably rigid. The two display halves are attached to each other by means of a hinge. By means of the hinge the two display halves are mounted to be pivotable relative to each other in a suitable manner. In this case, it is possible to place the two display halves on top of each other so that they are arranged in particular in parallel with each other and on top of each other. It is possible to place the two display halves in abutment with each other. Furthermore, it is expediently possible to unfold the display so that the two display halves are parallel to each other, but in a common plane. The hinge is suitably located in the plane between the two display halves. The hinge is preferably at least located in a plane that is parallel to the plane in which the two display halves lie. When the display unfolds, said hinge is expediently located behind the two display halves. In summary, it is particularly preferably possible to pivot the two display halves relative to each other by 180° or at least by 160° or 170°. The pivot axis runs, for example, along an edge of each of the display halves or is offset outward from the edge. Preferably, the pivot axis is parallel to at least one of the edges of the respective display half.

The two display halves in particular provide a common display area. For example, the two display halves are covered by a common film or substrate so that no transition between the display halves is visible when the display is in the unfolded state. Alternatively, they can be separate from each other, thus reducing manufacturing costs. The display in particular uses LCD technology, plasma technology or, particularly preferably, LED technology. In other words, it is suitably an LED display, preferably an OLED display.

The hinge is mounted so as to be movable by means of a guide in an adjustment direction, the adjustment direction suitably being essentially straight. At least any curvature is less than 20°, 10° or 5°. Mounting the hinge makes it possible, in particular by means of the hinge, to move the entire display in the adjustment direction by means of the guide. In this case, the guide engages directly with the hinge, for example, or the hinge is connected to the guide via other components, such as one of the display halves.

The display device also comprises an electric-motor-operated adjustment drive that drives the display. In particular, the hinge is at least partially driven in this case so that it is moved in the adjustment direction by means of the electric-motor-operated adjustment drive when the electric-motor-operated adjustment drive is operated. An alternative combination is, for example, to use the electric-motor-operated adjustment drive to drive one of the display halves with respect to the hinge and/or the other display half.

The electric-motor-operated adjustment drive preferably comprises an electric motor, which is designed, for example, as a brushed commutator motor, or is expediently brushless. Preferably, the electric motor is a synchronous motor and suitably a brushless DC (BLDC) motor. The electric motor preferably drives a transmission of the electric-motor-operated adjustment drive, by means of which, for example, gearing-down or gearing-up and/or changing direction is performed. Preferably, the transmission is designed to be self-locking so that adjustment is only possible by operating the electric-motor-operated adjustment drive. The display unit is thus only adjusted when the electric-motor-operated adjustment drive is operated. Alternatively, self-locking is not provided, so that manual actuation is also possible.

The display device makes it possible to reduce the size of the display or at least its extent in one plane, namely by pivoting the two display halves relative to each other by means of the hinge. This reduces the space required, in particular when the display is folded up. In an unfolded state, on the other hand, the display region is enlarged, thus increasing comfort. Furthermore, since the hinge is mounted so as to be movable in the adjustment direction, it is possible to additionally move the entire display so that it can be, for example, stowed away appropriately and/or moved closer to a seat of the motor vehicle and thus be presented to a user, such as a driver or a passenger of the motor vehicle. This increases comfort. Mounting the hinge by means of the guide reduces complexity and therefore reduces manufacturing costs. Since the display is driven by means of the electric-motor-operated adjustment drive, for example the display device requires no manual actuation at all, or only some manual actuation, in order to use or stow it. Accordingly, comfort is further increased. Since it is possible to reduce the extent of the display due to the hinge, the space required for installation and removal is reduced, and for this reason it is not necessary to remove other components of the motor vehicle to do so. If mounting/removal is carried out when the display is in the folded state, any components that also need removing will be at least significantly smaller. This makes mounting, maintenance, and replacement easier.

For example, the hinge is designed in the style of a door hinge, concealed hinge or tab hinge. Alternatively, it can be designed as a piano hinge. Alternatively, the hinge is designed as a four-bar linkage or a four-bar chain. For example, the hinge only provides a single pivot axis. Alternatively, the hinge comprises, for example, a support plate on which each display half is movably mounted. Provided that the display halves are relatively thick, it is thus possible, by means of appropriate kinematics, to pivot the display halves relative to each other without them rubbing against each other, wherein, when in the unfolded state, essentially no gap is formed between them and for this reason the display region is essentially continuous.

For example, the hinge is driven by means of the electric-motor-operated adjustment drive, for example directly or indirectly, so that the display is driven in the adjustment direction by means of the electric-motor-operated adjustment drive. For adjusting the two display halves, for example, a separate electric-motor-operated adjustment drive is provided, and the two display halves and the hinge, which expediently comprises the possible support plate, are designed as a gripper arm/gripper. In another alternative, the two display halves are driven by means of the electric-motor-operated adjustment drive so that they can be pivoted by means of the electric-motor-operated adjustment drive.

For example, the shaft is formed by means of a dashboard or armrest of the motor vehicle, or is at least mounted there. Expediently, the display device comprises a shaft, which is provided, for example, by means of an essentially hollow-cylindrical box. The shaft preferably has an opening by means of which the shaft is delimited in one direction in the adjustment direction. The display device is suitably designed in such a way that, when the display is in the folded state, i.e. when the two display halves are folded together, the entire display is arranged within the shaft and is thus protected. When in the unfolded state, the display will on the other hand be preferably arranged outside the shaft. This reduces the space required for the shaft, while a comparatively large display area is nevertheless provided by means of the display. The shaft also makes it easier to guide the display in the adjustment direction.

For example, the display device has two rollers between which the two display halves are arranged, at least in the folded state. The two rollers are preferably rotatable, with one or both preferably being driven by means of the electric-motor-operated adjustment drive. The two display halves preferably each abut one of the rollers by means of their rear sides. In particular, the two rollers are parallel to each other and perpendicular to the adjustment direction. When the roller(s) are made to rotate by means of the electric-motor-operated adjustment drive, the display is consequently also moved in the adjustment direction.

The shaft is preferably provided in this case, and the two rollers are arranged in the region of a mouth/the opening of the shaft. In this case, the display lies with in the shaft when in the folded state, i.e. when the two display halves are lying on top of each other. However, when in the unfolded state, the display is at least partially arranged outside the shaft. Preferably, the two display halves are spring-loaded in the region of the hinge. In this case, the spring is preferably designed and/or arranged in such a way that the display is folded open, i.e. the two display halves are pivoted into the common plane, provided no other forces are acting thereon. When the display is arranged inside the shaft, it cannot be folded open due to the walls of the shaft. When the display is moved out of the shaft by means of the rollers, the display is gradually allowed to fold open so that it unfolds automatically. The display is thus adjusted in the adjustment direction and folded open by means of the drive of the roller(s), which reduces the number of components required. For example, the hinge is additionally guided, increasing robustness. Alternatively, the hinge is only guided by means of the rollers, which reduces the number of components required.

For example, the hinge is mounted on the guide by means of the displays and, with the exception of the display halves, is not in direct mechanical contact with any other components of the display device. However, the display device particularly preferably comprises a main slide, which is a component of the guide and to which the hinge is connected. For example, one of the display halves is not movable relative to the main slide and is rigidly attached thereto, for example. However, the display halves are particularly preferably mounted so as to be pivotable relative to the main slide by means of the hinge, in particular in each case by 90° or at least 70° or 80°. This simplifies a design.

The main slide is movable, in particular in the adjustment direction. For example, the hinge is attached to the main slide or at least supported thereon. Preferably, the position of the hinge is directly determined by means of the main slide.

The main slide, for example, is movably mounted on a guide rail or guide rod. The guide rod/guide rail extends in particular in parallel with the adjustment direction, which simplifies a design. For example, the main slide is connected to the guide rail by means of a sliding bearing or a roller bearing. In particular, the main slide at least partially encompasses the edge of the guide rail so that detachment from the guide rail is in particular only possible in the adjustment direction, increasing robustness and simplifying a design.

For example, only one such main slide is provided, or two are expediently provided that are spaced apart from each other perpendicularly to the adjustment direction. This prevents the display from tilting when it is moved in the adjustment direction, thus increasing robustness.

Expediently, the hinge is driven by means of the electric-motor-operated adjustment drive, preferably via the main slide, which is connected, for example, to the electric-motor-operated adjustment drive. This simplifies a design. This also makes it possible, for example, to detach the display from the other components of the display device, especially from the main slide, making it easier to replace. Modular manufacturing is also possible, wherein, for example, the display can be sourced from one manufacturer and the other components of the display device from another manufacturer.

The shaft in which the main slide is arranged and mounted in the adjustment direction is expediently provided. In particular, the main slide is always, or at least predominantly, located within the shaft, or at least the possible guide rail. It is thus protected and expediently not visible, which improves the visual impression. In this case, the display device is preferably designed and the main slide is expediently mounted in the shaft and driven by means of the electric-motor-operated adjustment drive such that the hinge can be moved out of the shaft. Preferably, it is therefore also possible to move the hinge and expediently the entire display into the shaft, at least when in the folded state. Since the hinge can be moved out of the shaft, the display can consequently also be moved out of the shaft, where it is expediently in the unfolded state. The display is thus not obstructed by the shaft, although the shaft still at least partially protects the display when it is in the folded state. Preferably, it is possible to arrange the entire display in the shaft when it is in the folded state, wherein the two display halves then suitably lie flat against each other. When the hinge is moved out of the shaft, the entire display is in particular will also be arranged outside the shaft, and it is possible to arrange the two display halves in the common plane. Preferably, the ends of the display halves further away from the hinge are shifted toward the mouth of the shaft when the display is in the folded state, i.e. when it is in the shaft. The pivot axis about which the display halves are pivotally mounted is expediently perpendicular to the adjustment path.

Due to such a design, it is possible to stow the display in the shaft so that it is protected and in particular out of a field of view of the driver of the motor vehicle. The space required is relatively small, and for this reason the shaft can also be mounted in the region of the dashboard or armrest, for example. Since the main slide is provided, no manual action is required to move the display in and out of the shaft, thus increasing comfort. For this reason, injury to the driver is also ruled out, for example should the shaft be comparatively thin and/or sharp-edged.

For example, the display halves are only mounted in the adjustment direction by means of the hinge. Alternatively, these each have, for example, an elongated hole in each of which a pin is inserted. The pins are expediently arranged perpendicularly to the adjustment direction and in parallel with each of the display halves. When the hinge is moved in the adjustment direction, each pin slides along in the respective elongated hole. This prevents uncontrolled movement of the display halves when the display is being adjusted in the adjustment direction. Expediently, the display device is designed in such a way that when the display is moved out of the shaft, each pin must reach the end of the respective elongated hole before adjustment of the hinge is prevented. As the hinge continues to move, each of the display halves is thus rotated around the respective pin, which thus provides the respective pivot axis. Suitably, each of the display halves is assigned two pins that lie on a common axis and are located on opposite sides of each display half. Each of these sides expediently comprises the corresponding elongated hole. This increases stability. The pins and elongated holes simplify a design and ensure that the display unfolds when extending and folds up when retracting. No additional drive is required for the display, thus reducing manufacturing costs.

As an alternative to the elongated holes and the pins, two levers are in particular provided, each of which is pivotally mounted on one of the display halves. The connection point between each lever and the respective display half is shifted, in particular, away from an end of the respective display half that is closer to the hinge. The other end of the lever is expediently held in a fixed position, particularly on the shaft. Due to the levers, when the hinge is moved in the adjustment direction, the ends of the display half facing the hinge are thus moved in the adjustment direction, while at the same time the two display halves are forcibly pivoted relative to each other. In particular, the points where the levers connect to the shaft are located on opposite boundaries. The levers also simplify a design, whereby the display halves are forcibly adjusted relative to each other. Here, too, no additional drive is required for the display halves.

In a development, the lever is present that is pivotally connected to one of the display halves. The connection point between the lever and the display half is expediently shifted away from the hinge. The lever itself is pivotally connected to an additional slide. Provided that the additional slide is moved synchronously with the main slide, the state of the display is not changed but it is simply moved in the adjustment direction. However, if the additional slide moves relative to the main slide, the display will be folded up or unfolded. This makes it possible, for example, to unfold the display only when it has been completely moved out of the possible shaft, thus increasing flexibility and reducing wear. This also places lower demands on the shaft, and it can, for example, be relatively narrow, since the display is only unfolded once it has been moved out of the shaft.

Preferably, each display half is assigned a corresponding additional slide, which simplifies a design. Preferably, the additional slide(s) is (are) mounted by means of a separate guide rod or guide rail in each case, which, for example, initially extends essentially in parallel with the mounting of the main slide. In the region of the mouth of the possible shaft, the guide rail/guide rod of the additional slide leads away from the main slide and expediently curves, with the curve extending, for example, until it is facing the opposite direction. The guide rail/guide rod of the additional slide is thus designed to be essentially shaped like a walking stick. In particular, the additional slide is only moved in the region of the curve, or is at least predominantly moved, when the movement of the main slide has been stopped/ended. The display thus unfolds later than when the display is being adjusted. In particular, the additional slide(s) is (are) driven by means of a further drive, which increases flexibility when the display is being adjusted/moved. Alternatively, these are coupled to the electric-motor-operated drive, reducing manufacturing costs and cabling outlay.

In another alternative, the additional slide is mounted on the main slide. It is particularly preferred that each display half is assigned the additional slide, so that the two display halves can be adjusted separately. This increases flexibility. In addition, two main slides are expediently provided, with one of the main slides being assigned the one additional slide and the other main slide being assigned the other additional slide. This simplifies a design.

In an alternative, the two additional slides are mounted on the main slide, and only a single main slide is provided. The number of components required is thereby reduced. In another alternative, only a single additional slide is provided, to which the two display halves are, however, connected via the respective lever. They are essentially always adjusted synchronously, reducing complexity and the number of components required.

In another alternative, for example, the additional slides are not mounted on the main slide, but on the guide of the main slide(s), in particular on any guide rail/guide rod present. The additional slides are offset, in particular with respect to the main slide, in the adjustment direction. To move the entire display, the additional slides are moved synchronously with the main slide. For unfolding, however, the main slide is held in place, and the additional slides are moved back again. A kind of umbrella principle is thus implemented. In another alternative, for example, the main slide is no longer provided but only the additional slide by means of which the two display halves are pivotally connected via the levers. In particular, a stop or the like is provided, against which the hinge is moved by means of the additional slides. Here, the slide is held, for example by means of a fastening or by means of acting springs, and the additional slides are moved in the opposite direction to unfold the display. Here, too, adjustment and folding open/folding up are thus only possible by means of the electric-motor-operated drive, which reduces the number of required components. This takes place at different times, for this reason reducing wear. In another example, two additional slides or just one single additional slide is/are provided, to which both display halves are then connected by means of the respective lever.

For example, only the display halves are connected to each other by means of the hinge. In another alternative, an angular extension is rigidly connected to each display. The combination of the display halves and the particular extension is essentially L- or V-shaped. In this case, the extension is located on the side of the display halves facing the hinge, and the two extensions point away from each other. In particular, the extension remains within the possible shaft even when the display is in the unfolded state. Due to the extensions, the width of the display is increased when in the folded state. Inside the shaft, said display has an extent that is greater than the extent of the two extensions, in particular perpendicularly to the adjustment direction. This makes possible an unimpeded movement of the display within the shaft. However, the height of the opening of the shaft is less than the extent of the extensions, in particular perpendicularly to the adjustment direction, when the display is in the folded state. When the display is now being moved out of the shaft, the free ends of the display halves facing away from the extension are initially moved unhindered through the opening. This continues until the extensions reach the opening of the shaft. If the hinge then continues to move in the adjustment direction, the extensions will be partially held in the shaft, causing the display halves to pivot. During a reverse movement, i.e. when the display is retracting into the shaft, the reduced opening of the shaft causes the display halves to be pulled along the edges of the opening so that the display is folded up again. For this reason, no additional drive is required here either, facilitating a design.

Alternatively or in combination with the reduced height of the shaft opening, for example the two extensions are attached to each other by means of a spring mechanism, which is designed in particular as a tension spring. In other words, a spring is connected in particular to the ends of the extensions further away from the hinge. This spring can be designed, for example, as a spiral spring or as an elastic rubber band. The spring thus exerts a force on the extensions that pulls them toward each other and causes the ends of the display halves further away from the hinge to move apart. As long as the display is inside the shaft, said display is only partially unfolded, namely until the free ends of the display halves further away from the hinge abut the inside of the shaft. Further unfolding is for this reason prevented. If the display is now partially moved out of the shaft by means of the hinge/main slide, the display halves are gradually allowed to continue to pivot, namely until the extensions have moved closer together so as to have a minimal spacing, and the display is completely unfolded. For example, the spring is then relaxed but remains under tension, but to a lesser degree. When the display is pulled into the shaft by means of the main slide, the display halves are moved toward each other because of striking the opening, thereby tensioning the tension spring. For this reason, no additional drive is required here either, thereby reducing manufacturing costs.

In summary, the display halves are supported against each other, for example by means of the spring mechanism. It is also possible to omit if the angular extensions. The spring mechanism then engages directly on the hinge, for example, and is designed as a torsion spring, a torsion bar spring or a torsion bar. Alternatively or in combination, the spring mechanism comprises a compression spring. Here, too, as a result of the free ends of the display halves further away from the hinge abutting the inside of the shaft, the display is prevented from unfolding when it is inside the shaft. However, as soon as the display halves are moved out of the shaft, they are no longer held back, or only held back to a lesser extent, so that the display is unfolded, whereby the respective spring mechanism is at least partially relaxed. When the hinge is pulled into the shaft, the display halves are moved toward each other as a result of their striking the opening of the shaft, i.e. in particular the mouth, thereby tensioning the spring mechanism.

In a development, the display device comprises two angular support plates made of an elastic material. In this case, each support plate is L-shaped in the relaxed state and thus has two sides that abut each other at the edges and are arranged at 90° to each other. For example, the support plates are made of a spring steel and/or are identical in design.

In each case, one of the two sides of each support plate is attached to the other, for example are welded and/or riveted to each other. At the very least, these are suitably arranged in parallel with each other and/or so as to be congruent with each other. When the support plates are in the relaxed state, the other sides are arranged in particular in a common plane. Each of the display halves are connected thereto, for example attached thereto. The hinge is provided by means of the support plates, by means of which hinge the two display halves are attached to each other. This allows the two display halves to be pivoted on top of each other, for which purpose the support plate are elastically deformed. This is preferably done when the display is being pulled into the shaft. In particular, the sides of the support plates that are attached to each other are operated by means of the electric-motor-operated adjustment drive. In summary, each display half is therefore connected to one side of each angular support plate, which is made of the elastic material. The remaining sides of each support plate are, in particular, parallel to each other and interconnected to form the hinge.

In another alternative, the display device comprises a funnel into which the shaft opens. The funnel has two stop surfaces that are inclined relative to each other and are arranged in particular in parallel with the pivot axis of the display. Each display half is connected to one of the stop surfaces, expediently essentially in the center thereof, by means of a stretchable element, such as a rubber band, so as to be offset from the hinge. When the display is in the shaft, the stretchable elements at least partially pre-tension the display, thus reducing the force required by the electric motor adjustment drive to extend the display out of the shaft. As soon as the display is outside the shaft and partially inside the funnel, the display halves are unfolded due to the relaxation of the stretchable elastic elements, at least until they abut the corresponding stop surface. The funnel shape is thus replicated by means of the display. As the hinge continues to move in the adjustment direction, the display halves are at least partially held back by the stretchable elastic elements such that they are completely unfolded. The display only unfolds after leaving the shaft, and the display halves are at least partially stabilized by means of the funnel. No separate drive is required to unfold the display, which reduces manufacturing costs. The design is also simplified and complexity is reduced.

For example, the electric-motor-operated adjustment drive has a driven cable drum and a cable guide, by means of which each cable can be moved. The cable guide extends at least in portions in the adjustment direction and is, for example, arranged within the possible shaft. In particular, the possible main slide, or at least the hinge, is connected to the cable. When the electric motor is operated, the cable and therefore the hinge is thus moved, and consequently also the display. In this case, for example, the cable drum is driven by the electric motor directly or by the possible transmission. Due to the cable drum, a self-locking mechanism is in particular also implemented, and/or a wrap spring is provided, for example. This prevents unintentional adjustment of the display, i.e. in particular without the electric motor adjustment drive being operated.

In an alternative, the electric-motor-operated adjustment drive comprises a spindle and a spindle nut mounted thereon. For example, the spindle is driven by the electric motor, either directly or via a possible transmission, for example. However, it is particularly preferred for the spindle to be driven, for example directly or preferably via the possible transmission. The spindle nut is in particular connected to or formed with the main slide, which is expediently guided in a rotationally fixed manner. The spindle expediently extends in the adjustment direction and is in particular arranged within the possible shaft. For example, the nut is held at the edge of the main slide. However, it is particularly preferred for the spindle nut to be inserted into a recess in the main slide where it is held in a rotationally fixed manner. The spindle extends through the main slide, at least when the display is located inside the shaft. In this way, a comparatively space-saving design is achieved, ensuring secure movement of the display and a comparatively high robustness.

The invention further relates to a motor vehicle comprising a display device, which comprises a foldable display having a first display half and a second display half that are attached to each other by means of a hinge. The hinge is mounted so that it is movable by means of a guide in an adjustment direction. The display device also comprises an electric-motor-operated adjustment drive that drives the display.

The advantages and developments mentioned in connection with the display device may correspondingly also be transferred to the motor vehicle, and vice versa.

### BRIEF DESCRIPTION

In the following, examples of embodiments of the invention are explained in more detail with reference to a drawing. In the figures:

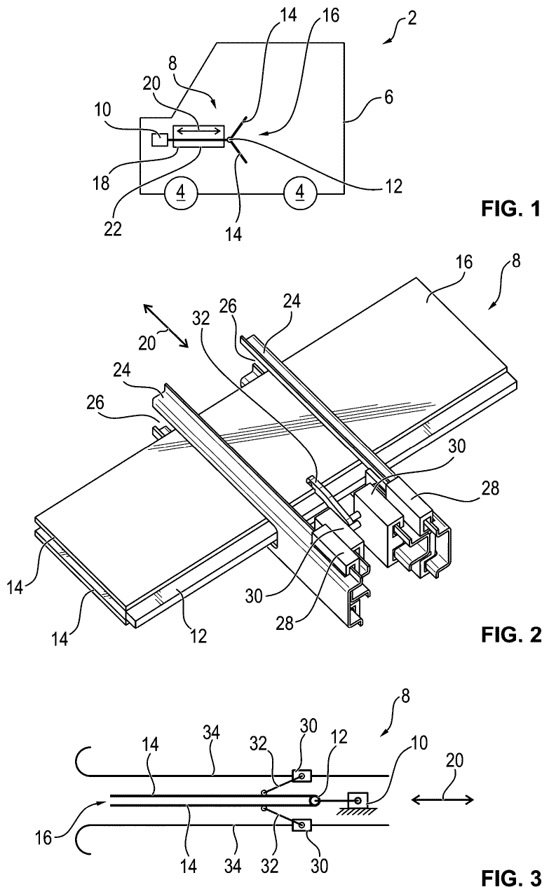

FIG. 1 is a schematic view of a motor vehicle comprising a display device having two display halves;

FIG. 2 is a perspective view of the display device; and,

FIGS. 3 through 14 show schematic lateral views of different variants of the display device.

### DETAILED DESCRIPTION

Corresponding parts are provided with the same reference numbers in all figures.

FIG. 1 shows a simplified schematic representation of a motor vehicle 2 in the form of a passenger car. The motor vehicle 2 has several wheels 4 which stand on the ground and which are connected to a body 6 by means of a chassis (not shown in detail). The motor vehicle 2 comprises a display device 8 which is arranged within an interior space provided by the body 6 and is partially integrated into a dashboard (not shown in detail).

The display device 8 has an electric-motor-operated adjustment drive 10, which comprises an electric motor (not shown in detail) and a transmission driven thereby. The electric-motor-operated adjustment drive 10 is operatively connected to a hinge 12, by means of which two display halves 14 of a display 16 are pivotally attached to each other. The two display halves 14 are identical in design and are in each case rigid. Due to the hinge 12, it is possible to fold the two display halves 14 together so that they are arranged one above the other. It is also possible to unfold the display 16 so that the two display halves 14 lie in a common plane, and a common display area is provided. In summary, the display 16 is therefore foldable.

Due to the operative connection between the electric-motor-operated adjustment drive 10 and the hinge 12, it is possible to retract the display 16 into a shaft 18, for which purpose the two display halves 14 are folded together and the entire display 16 is moved in an adjustment direction 20 that is parallel to the extension direction of the shaft 18. To prevent uncontrolled adjustment, the display device 8 comprises a guide 22 which extends at least in portions in the adjustment direction 20, and by means of which the display 16 is movably mounted. The guide 22 is located primarily within shaft 18.

FIG. 2 is a perspective view of the display device 8, but the electric-motor-operated adjustment drive 10 and the shaft 18 are not shown. The guide 22 has two guide rails 24 which are mirror images of each other and which extend in the adjustment direction 20. The guide rails 24 are located entirely within the shaft 18.

The two guide rails 24 are designed as a top-hat profile and have at one end a slot 26 extending in the adjustment direction 20, which shaft does not extend all the way through each guide rail 24. When the display 16 is folded up, i.e. when it is inside the shaft 18, the two display halves 14 lie on top of each other in the slots 26: The length of the slots 20 is greater than the height of the display halves 14. Thus, it is possible to stow the entire display 16 within the shaft 18.

On each guide rail 24 a main slide 28 of the guide 22 is mounted so as to be movable in the adjustment direction 10. The hinge 12 is attached to the main slide 28, and these are driven by means of the electric-motor-operated adjustment drive 10. In addition, an additional slide 30 is movably mounted on each main slide 28, namely in parallel with the adjustment direction 20. Each additional slide 30 has a lever 32 pivotally connected thereto. One of the levers 32 is pivotally connected to one of the display halves 14 and the other lever 32 (not shown in detail) is pivotally connected to the other display half 14, namely on the respective rear side and so as to always be offset away from the hinge 12.

When the display 16 is to be extended, the electric-motor-operated adjustment drive 10 is operated so that the hinge 12 is moved out of the shaft 18. For this purpose, the main slides 28 are designed and mounted accordingly. The guide rails 24 and the shaft 18 are also designed accordingly. In other words, the hinge 12 is connected to the main slide 28 of the guide 22 such the movably mounted in the shaft 18 in the adjustment direction 20 and are driven by means of the electric-motor-operated adjustment drive 10 so that the hinge 12 can be moved out of the shaft 18. When the hinge 12 is located outside the shaft 18, the additional slides 30 are moved synchronously counter to the adjustment direction 20 on the main slide 28. The main slide 28, however, is not moved. As a result, the hinge 12 remains in the same position but the display halves 14 are pivoted by means of the levers 32 so that the display 16 is unfolded. For example, by means of a mechanism (not shown in detail), the additional slides 30 are driven by means of the electric-motor-operated adjustment drive 10 or another drive.

In another alternative, the additional slides 30 are each pre-tensioned relative to the main slides 28 by means of a spring so that any adjustment counter to the adjustment direction 20 takes place due to the spring force applied. When the display 16 is moved into the shaft 18, because of the display halves 14 striking the ends of the guide rails 24 the display halves 14 are folded together, thereby tensioning the spring mechanism. In a further alternative, for example, the additional slides 30 are pre-tensioned in the direction of the display 16 with respect to the main slides 28. When the display 16 is extended from the shaft 18, the additional slides 30 are held back by a stop as the main slides 28 continue to move. As a result, the springs are tensioned and the display halves 14 are unfolded.

FIG. 3 schematically illustrates an alternative embodiment of the display device 8. The display 16, comprising the two display halves 14 which are attached to each other by means of the hinge 12, is not modified. The main slides 28 (not shown in detail) are also driven by means of the electric-motor-operated adjustment drive 10 and are mounted on the guide rails 26 to be movable in the adjustment direction 20 such that the hinge 12 can be moved in the adjustment direction 20. Furthermore, each lever 32 is in turn pivotally connected to each display half 14, each of which is pivotally connected to one of the additional slides 30. However, the additional slides 30 are no longer movably mounted on each main slide 28, but rather by means of a respective additional guide rail 34. These initially extend in parallel with the guide rails 26, but in the region of an opening of the shaft 18 curve away from each other in a walking stick shape. The additional slides 30 are driven by means of an additional drive (not shown in detail) or are driven by an additional mechanism via the electric-motor-operated adjustment drive 10. Here too, it is possible to move the hinge 12 out of the shaft 18 by means of the main slides 28. Further movement of the main slides 28 is then prevented due to a stop on the main slides 28 or a corresponding operation of the electric-motor-operated adjustment drive 10. The additional slides 30 are then moved along the walking-stick-shaped curve, which also causes the display 16 to unfold.

In summary, during the movement of the main slides 28, the additional slides 30 are forcibly guided in the additional guide rails 34 which act as respective guide tracks. Toward the end of the movement of the main slides 28 in the adjustment direction 20, the walking-stick-shaped design of the additional guide rails 34 and the connection between the additional slides 30 and the display halves 14 by means of the levers 32 cause the two display halves 14 to fold apart.

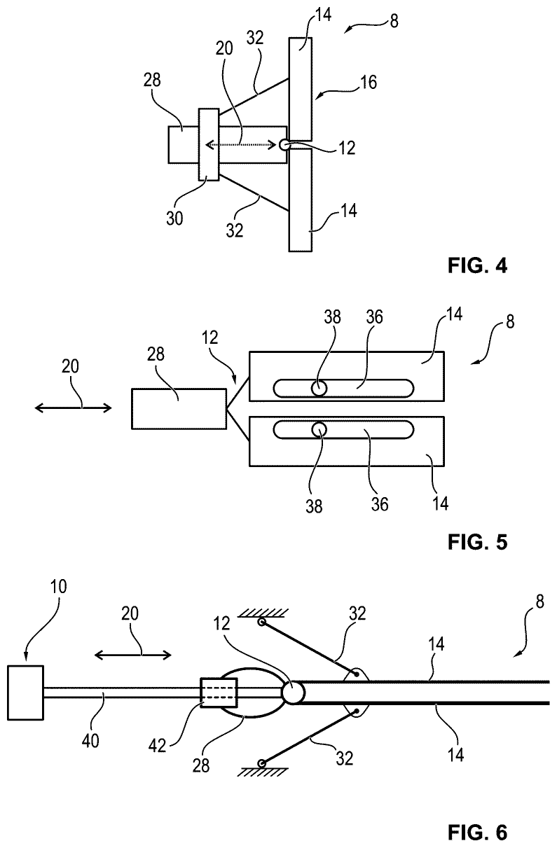

FIG. 4 is a schematic view of a further embodiment of the display device 8, which is based on the variant shown in FIG. 2. The display 16 comprising the two display halves 14 and the hinge 12 remains unchanged. Compared to the previous variant, only a single main slide 28 is provided, which is mounted in the adjustment direction 20 by means of the guide (not shown in more detail). Only a single additional slide 30 is provided, which is mounted on the main slide 28 to be movable in the adjustment direction 20, and to which the two levers 32 are pivotally connected. As a result, a kind of umbrella principle is implemented. Provided the main slide 28 and the additional slide 30 are moved synchronously in the adjustment direction 20, the entire display 16 could be moved in the adjustment direction 20. If, however, there is a relative movement between the two slides 28, 30, the display 16 will be unfolded or folded up. In one variant (not shown in detail), the hinge 12 is movably mounted directly on the guide rail 24 so that the main slide 28 is formed by means of the hinge 12.

FIG. 5 is a schematic lateral view of a further alternative of the display device 8. Here, too, the main slide 28 is present, to which the hinge 12 is connected. However, said hinge is now designed in the form of a four-bar linkage. An elongated hole 36 is also provided on the edge of each of the opposite sides of each of the display halves 14. Each elongated hole 36 contains a pin 38, which is rigidly held on the shaft 18 and arranged perpendicularly to the adjustment direction 20. All the pins 38 lie in a common plane. When the main slide 28 is moved in the adjustment direction 20, the pins 38 initially slide in the elongated holes 36, wherein the display halves 14 are essentially only moved in the adjustment direction 20. This prevents the display halves 14 from unfolding uncontrollably. However, as soon as the pins 38 strike one of the ends of the elongated holes 36 in the adjustment direction 20, further movement of the display halves 14 in the adjustment direction 20 is prevented. If the main slide 28 and thus the hinge 12 now continue to be moved in the adjustment direction 20, this leads to the display halves 14 being unfolded about the pivot axes provided by each of the pins 38. Here too the display 16 is unfolded, wherein different drives are not required for unfolding and adjusting in the adjustment direction 20.

FIG. 6 shows a further alternative of the display device 8. The electric-motor-operated adjustment drive 10 comprises a spindle 40, which is arranged in the adjustment direction 20, is arranged entirely within the shaft 18 and is driven by the electric motor via a transmission (not shown in detail). A spindle nut 42, to which the main slide 28 is attached, is mounted on the spindle 40, said slide being mounted in a rotationally fixed manner by means of the guide 22 but still movable in the adjustment direction 20. The hinge 12 is in turn attached to the main slide 28.

The two display halves 14 are attached to each other by means of the hinge 12, on which the respective lever 32 is pivotally mounted, but which is now pivotally mounted on the shaft 18 where it is held in a fixed position. Thus, when the electric-motor-operated adjustment drive 10 is operated, the spindle nut 42 is moved along the spindle 40 in the adjustment direction 20, which leads to the adjustment of the main slide 28 and the hinge 12. As a result, the ends of the display halves 14 pointing towards the hinge 12 are also moved in the adjustment direction 20, with the display halves 14 simultaneously pivoting due to the levers 32.

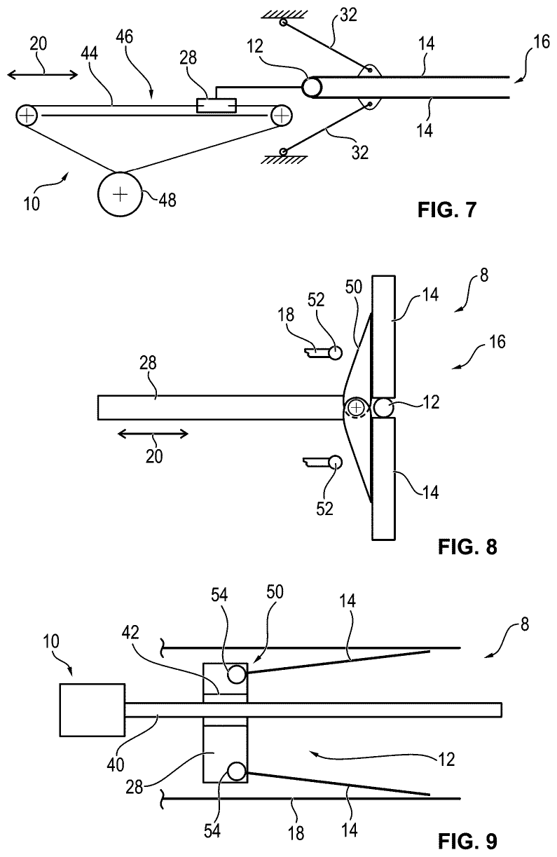

FIG. 7 shows a modification in which there is no change to the display 16 comprising the two display halves 14 and the connection to the shaft 18 by means of the two levers 32. However, the main slide 28 is now attached to a cable 44, which, in one region, is arranged in the adjustment direction 20 by means of a cable guide 46. The electric-motor-operated adjustment drive 10 also comprises a cable drum 48, onto which the cable 44 is wound and which is driven by means of the electric motor (not shown in detail). When the electric motor is operated, the cable 44 is therefore moved, causing the main slide 28 to be adjusted in the adjustment direction 20. The display 14 unfolds in the same way as in the previous embodiment.

FIG. 8 shows a further alternative of the display device 8, which comprises the main slide 28 which is mounted so as to be movable in the adjustment direction 20. The hinge 12 is connected to the main slide 28, by means of which hinge the two display halves 14 are attached to each other. In addition, a spring mechanism 50 is attached to the main slide 28 and is designed as a torsion spring. By means of the spring mechanism 50, the display halves 14 are spring-loaded, and, provided there are no further forces or restrictions, the display 16 is moved into the unfolded state due to the spring mechanism 50. In other words, the two display halves 14 are supported against each other by means of the spring mechanism 50. The shaft 18 has two stoppers 52 at its opening which act as stops. When the main slide 28 is being moved and the display 16 is retracted into the shaft 18, the two display halves 14 strike the stoppers 52 with their rear side and are folded together when the main slide 28 continues to move into the shaft 18, thereby tensioning the spring mechanism 50. It is thus also possible here to move the entire display 16 into shaft 18. In the case of the main slide 28 moving in the opposite direction, the display halves 14 are unfolded due to the acting spring mechanism 50 as soon as the display halves 14 have been moved out of the shaft 18.

FIG. 9 shows a further alternative of the display device 8, in which the spindle 40 driven by the electric motor is also provided, on which spindle the spindle nut 42 is mounted. The edge of the spindle nut 42 is completely enclosed by the main slide 28, through which the spindle 40 extends. The two display halves 14 are each pivotally mounted on the main slide 28, namely by means of a respective torsion bar 54. The two torsion bars 54 are spaced apart from each other and these together with a part of the main slide 28 form the hinge 12. In addition, the spring mechanism 50 is provided by means of the torsion bars 54. Here, too, the spring mechanism 50 ensures that as soon as the display 16 is outside the shaft 18, the two display halves 14 are unfolded.

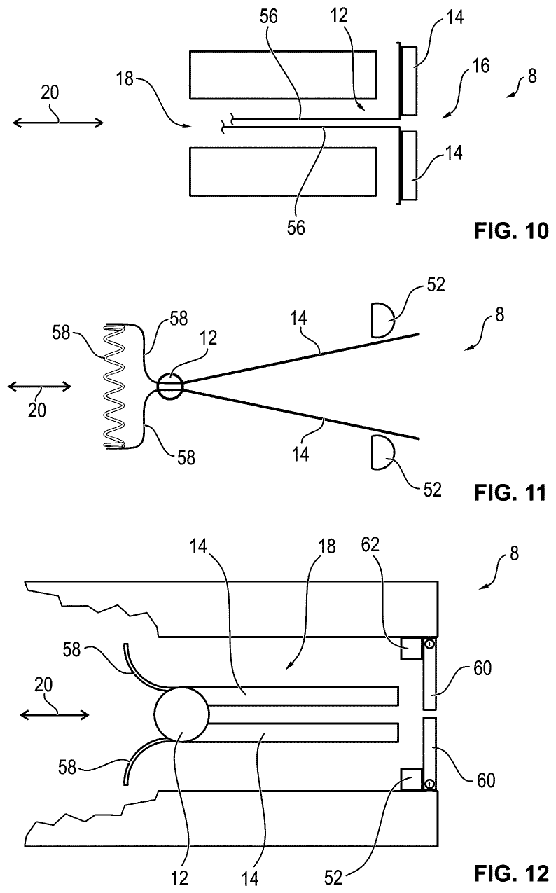

FIG. 10 shows a further alternative of the display device 8. The display device 18 comprises two support plates 56 made of spring steel that are angled so that their cross-section parallel to the adjustment direction 20 is L-shaped when no other forces are acting thereon. In each case, one of the sides of each support plate 56 is parallel to the adjustment direction 20 and these are parallel to each other. These sides are also congruent and attached to each other so that the hinge 12 is provided. The remaining sides of each support plate 56 point away from each other. One of the display halves 14 is attached to each of these. Provided the display halves 14 and the corresponding sides of the support plate 56 are located outside the shaft 18, the two display halves 14 will lie in a common plane. When the attached sides of the two support plates 56 are moved in the adjustment direction 20 into the shaft 18, the display halves 14 and the corresponding sides of the support plate 56 are pulled into the shaft 18, whereby the support plates 56 are elastically deformed, which leads to the two display halves 14 folding together.

FIG. 11 shows a further embodiment of the display device 8, which is based on the variant shown in FIG. 8. Here, too, the two stoppers 52 are provided in the region of the opening of the shaft 18, and the hinge 12 is mounted to be movable in the adjustment direction 20 by means of the main slide 28 (not shown in detail). An angled extension 58 projecting beyond the hinge 12 is connected to the ends of each display half 14 which are shifted into the shaft 18, which angular extensions are thus located on the opposite side of the hinge 12 to the respective assigned display half 14 in the adjustment direction 20. The extensions 58 and the respective display half 14 are located on the same side with respect to a plane that is defined by the adjustment direction 20 and the pivot axis of the display 16.

The free ends of the extensions 58 point away from each other, at least when the display 16 is folded together. The spring mechanism 58, which is designed as a tension spring, is connected to the free ends. Consequently, due to the spring mechanism 50, the free ends of the extensions 58 are drawn toward each other, which causes the display 16 to unfold. The whole time the display 16 is inside the shaft 18, this unfolding is prevented by the display halves 14 striking the inside of the shaft 18. However, when the display 16 is moved out of the shaft 18 by means of the electric-motor-operated adjustment drive 10, this restraint of the unfolding process is gradually lifted and the display 16 is therefore unfolded. When the display 16 is being retracted into the shaft 18, the rear sides of the display halves 14 strike the stoppers 52 so that the display is folded together, just as in the variant shown in FIG. 8, thereby tensioning the spring mechanism 50.

In an alternative embodiment, the extension 58 and each associated display half 14 are arranged crosswise with respect to the hinge 12 so that a kind of scissors is realized. In this case, the spring mechanism 58 is provided by means of a compression spring, by means of which the free ends of the extensions 58 are pushed away from each other.

FIG. 12 shows a further modification, which shows a further development of the variant of the display device 8 shown in FIG. 11. Here, too, the two extensions 58 are provided, which are connected to the display halves 14 and extend beyond the hinge 12. The extensions 58 and the respective display half 14 are located on the same side of a plane which is defined by the pivot axis of the hinge 12 and the adjustment direction 20, and the free ends of the extensions 58 point away from each other when the display 16 is folded together. The extent of the extensions 58 perpendicularly to the adjustment direction 20 is less than the height of the shaft 18 so that undisturbed movement of the display 16 within the shaft 18 in the adjustment direction 20 when it is folded up is made possible by means of the main slide 28 (not shown in detail). The opening of the shaft 18 is covered by means of two flexible lips 60, which are assigned to opposite sides. The lips 60, which are made of rubber, are each attached to a connecting piece 62 arranged on the inside of the shaft 18 such that the height of the opening of the shaft 18 is reduced. When the display 16 is being moved out of the shaft 18, the free ends of the display halves 14 are pushed through the opening, resulting in elastic deformation of the lips 16. As the main slide 28 continues to move, the display halves 14 also continue to move in the adjustment direction 20, namely until the extensions 58 strike the connecting pieces 62. As soon as the hinge 12 and the main slide 28 then continue to move in the adjustment direction 20, a force acts on the extensions 58 that causes the display halves 14 to pivot. When the display 16 is being retracted into the shaft 18, the elastic lips 60 ensure that the two display halves 14 are folded together again.

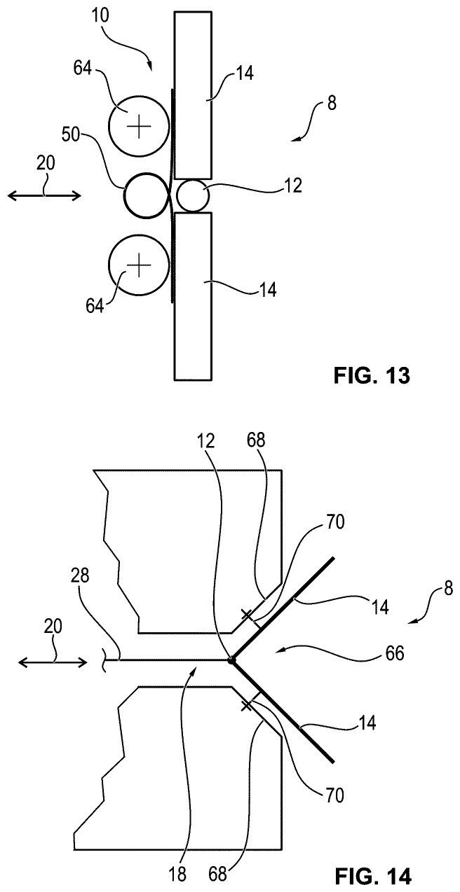

FIG. 13 shows a further embodiment of the display device 8, which is based on the variant shown in FIG. 8. Here, too, the spring mechanism 50 is provided, which is designed as a torsion spring by means of which the two display halves 14 are supported against each other, these display halves being attached to each other by means of the hinge 12. For example, the main slide 28 (not shown in detail) is also provided here, or the spring mechanism 50 itself is mounted to be movable in the adjustment direction 20 by means of the guide 22 (not shown in detail). The opening of the shaft 18 is now delimited by means of two rotatably mounted rollers 64 of the electric-motor-operated adjustment drive 10, whose axis of rotation is parallel to the pivot axis of the display 16, and which abut the rear side of the display halves 14. The display halves 14 are moved depending on the direction of rotation of the rollers 64, wherein the spring mechanism 50 ensures that the display halves 14 are unfolded as soon as they are moved out of the shaft 18. Each of the display halves 14 is at least partially moved about the axis of rotation of the respective roller 64.

FIG. 14 shows a final variant of the display device 8, which corresponds to a development of the embodiment shown in FIG. 6 or 7. Here, too, the main slide 28 (not shown in detail) is mounted within the shaft 18 to be movable in the adjustment direction 20. The hinge 12 is attached to the main slide 28, by means of which hinge the two display halves 14 are connected to each other. The shaft 18 now opens into a funnel 66, which has two stop surfaces 68 that are inclined with respect to each other. The stop surfaces 68 are parallel to the pivot axis of the display 16, which is defined by the hinge 12. In summary, the shaft 18 opens into the funnel 66, which has two stop surfaces 68 inclined with respect to each other.

Each display half 14 is connected to one of the stop surfaces 68 by means of an elastically stretchable element 70, which is provided by means of a respective rubber band. Each elastically stretchable element 70 thus extends between the respective stop surface 68 and the associated display halves 14. The connection of the elastically stretchable elements 70 is here offset away from the hinge 12 and in particular in such a way that the connection points on the corresponding display half 14 and on the corresponding stop surface 68 are congruent when the display halves 14 abut the stop surface 68.

When the display 16 is pulled into the shaft 18, the funnel 66 ensures that the display 16 is folded up without the display halves 14 getting caught on the edge of the shaft 18. When the hinge 12 is being moved out of the shaft 18 in the adjustment direction 20, the display halves 14 are first unfolded because of the stretchable elastic elements 68 until they are parallel to the stop surfaces 68, and the stretchable elastic elements 70 are relaxed. When the hinge 12 continues to move in the adjustment direction 20, the display halves 14 are partially pivoted back, namely until they abut the edge of the funnel 66. Thus, here too, the display 16 unfolds without requiring an additional drive to unfold it.

The invention is not restricted to the embodiments described above. Rather, other variants of the invention can likewise be derived from this by the person skilled in the art without departing from the subject matter of the invention. In particular, all individual features described in connection with the individual embodiments can further also be combined with one another in other ways without departing from the subject matter of the invention.

### LIST OF REFERENCE SIGNS

2 Motor vehicles
4 Wheel
6 Body
8 Display device
10 Electric-motor-operated adjustment drive
12 Hinge
14 Display half
16 Display
18 Shaft
20 Adjustment direction
22 Guide
24 Guide rail
26 Slot
28 Main slide
30 Additional slide
32 Lever
34 Additional guide rail
36 Elongated hole
38 Pin
40 Spindle
42 Spindle nut
44 Cable
46 Cable guide
48 Cable drum
50 Spring mechanism
52 Stopper
54 Torsion bar
56 Support plates
58 Extension
60 Lips
62 Connecting piece
64 Roller
66 Funnel
68 Stop surface
70 Elastically stretchable element

What is claimed is:

1. A display device for a motor vehicle, comprising a foldable display having a first display half and a second display half attached to each other by means of a hinge that is mounted so as to be movable by means of a guide in an adjustment direction, and comprising an electric-motor-operated adjustment drive that drives the display.

2. The display device according to claim 1, wherein the hinge is connected to a main slide of the guide that is mounted in a shaft in the adjustment direction and is driven by means of the electric-motor-operated adjustment drive such that the hinge can be moved out of the shaft.

3. The display device according to claim 2, wherein one of the display halves is pivotally connected to an additional slide by means of a lever, which slide is offset away from the hinge.

4. The display device according to claim 3, wherein the additional slide is mounted on the main slide.

5. The display device according to claim 2, wherein an angular extension projecting beyond the hinge is connected to the two display halves, the height of an opening of the shaft being less than the extent of the extensions.

6. The display device according to claim 2, wherein the two display halves are supported against each other by means of a spring mechanism.

7. The display device according to claim 2, wherein the shaft opens into a funnel having stop surfaces that are inclined relative to each other, each display half being connected to one of the stop surfaces by means of an elastically stretchable element in a manner offset away from the hinge.

8. The display device according to claim 2, wherein the electric-motor-operated adjustment drive has a spindle and a spindle nut mounted thereon, to which the main slide is connected.

9. The display device according to claim 3, wherein the two display halves are supported against each other by means of a spring mechanism.

10. The display device according to claim 4, wherein the two display halves are supported against each other by means of a spring mechanism.

11. The display device according to claim 5, wherein the two display halves are supported against each other by means of a spring mechanism.

12. The display device according to claim 3, wherein the shaft opens into a funnel having stop surfaces that are inclined relative to each other, each display half being connected to one of the stop surfaces by means of an elastically stretchable element in a manner offset away from the hinge.

13. The display device according to claim 4, wherein the shaft opens into a funnel having stop surfaces that are inclined relative to each other, each display half being connected to one of the stop surfaces by means of an elastically stretchable element in a manner offset away from the hinge.

14. The display device according to claim 5, wherein the shaft opens into a funnel having stop surfaces that are inclined relative to each other, each display half being connected to one of the stop surfaces by means of an elastically stretchable element in a manner offset away from the hinge.

15. The display device according to claim 6, wherein the shaft opens into a funnel having stop surfaces that are inclined relative to each other, each display half being connected to one of the stop surfaces by means of an elastically stretchable element in a manner offset away from the hinge.

16. The display device according claim 3, wherein the electric-motor-operated adjustment drive has a spindle and a spindle nut mounted thereon, to which the main slide is connected.

17. The display device according claim 4, wherein the electric-motor-operated adjustment drive has a spindle and a spindle nut mounted thereon, to which the main slide is connected.

18. The display device according claim 5, wherein the electric-motor-operated adjustment drive has a spindle and a spindle nut mounted thereon, to which the main slide is connected.

19. The display device according claim 6, wherein the electric-motor-operated adjustment drive has a spindle and a spindle nut mounted thereon, to which the main slide is connected.

20. The display device according claim 7, wherein the electric-motor-operated adjustment drive has a spindle and a spindle nut mounted thereon, to which the main slide is connected.
